(19) United States
(12) Patent Application Publication
(10) Pub. No.: US 2026/0357894 A1
(43) Pub. Date: Nov. 12, 2026

(54) ACTUATOR FOR PROVIDING A FLUID FLOW AND A FURTHER ACTUATING FUNCTION

(71) Applicant: Schaeffler Technologies AG & Co. KG, Herzogenaurach (DE)

(72) Inventors: Peter Greb, Ottersweier (DE); Laszlo Man, Ottersweier (DE)

(73) Assignee: Schaeffler Technologies AG & Co. KG, Herzogenaurach (DE)

(21) Appl. No.: 19/112,985

(22) PCT Filed: Aug. 31, 2023
(86) PCT No.: PCT/DE2023/100634

§ 371 Date: Mar. 19, 2025

(30) Foreign Application Priority Data
Sep. 27, 2022 (DE) 10 2022 124 760.0

(51) Int. Cl. F16H 63/34

(52) U.S. Cl. CPC F16H 63/3483; F16H 63/3441; F16H 63/3466

(57) ABSTRACT

The disclosure relates to an actuator having a further actuating function, the actuator having: i) an electromotive drive accommodated in an actuator housing, the electromotive drive including a stator and a drive rotor that can be rotated about an axis of rotation; ii) a fluid-conveying device, a conveying rotor of the fluid-conveying device connected to the drive rotor for conjoint rotation therewith; iii) an eccentric being positioned, via a first freewheel, on a drive shaft that is connected, coaxially to the axis of rotation, to the conveying rotor; and iii) a freewheel lever mounted indirectly on an output shaft via a second freewheel. The eccentric causes the freewheel lever at least indirectly to move in an oscillating manner in the peripheral direction of the output shaft, and a linear actuating element driven by the oscillating movement and/or a rotationally driven actuating element is guided out of the actuator housing.

### CROSS-REFERENCE TO RELATED APPLICATIONS

This application is the U.S. National Phase of PCT Application No. PCT/DE2023/100634 filed on Aug. 31, 2023, which claims priority to DE 10 2022 124 760.0 filed on Sep. 27, 2022, the entire disclosures of which are incorporated by reference herein.

### TECHNICAL FIELD

The present disclosure relates to an actuator for providing a fluid flow for cooling and/or lubrication as well as an additional actuating function having only one electromotive drive and no other active switching elements.

### BACKGROUND

From the European patent specification EP 3 126 696 B1, an actuator for clutch actuation with a motor module and an actuation module is known, which can be a mechanical module or a hydraulic module. From the German patent specification DE 10 2016 218 118 B4, an electric pump actuator for actuating a parking lock with a hydraulic, double-acting cylinder-piston unit is known. What both patents have in common is that the actuators used are only designed for providing a fluid flow. Consequently, the actuators known from the prior art only provide cooling, lubrication or hydraulic pressure.

### SUMMARY

On this basis, the present disclosure is based on the object of at least partially overcoming the disadvantages known from the prior art and in particular of providing an actuator which, in addition to providing a fluid flow, purely mechanically provides an actuating function in order to avoid hydraulic losses and for reasons of robustness and which can be adapted to the requirements of different tasks by varying the properties of the actuating function of simple components.

This object is achieved with the features described herein.

The actuator according to the disclosure having a further actuating function comprises an electromotive drive accommodated in an actuator housing, the electromotive drive comprising a stator and a drive rotor that can be rotated about an axis of rotation, and with a fluid-conveying device, a conveying rotor of the fluid-conveying device being connected to the drive rotor for conjoint rotation therewith, wherein an eccentric is positioned, via a first freewheel, on a drive shaft that is connected, coaxially to the axis of rotation, to the conveying rotor, a freewheel lever being mounted indirectly on an output shaft via a second freewheel, the eccentric causing the freewheel lever at least indirectly to move in an oscillating manner in the peripheral direction of the output shaft, and a linear actuating element driven by said oscillating movement and/or a rotationally driven actuating element being guided out of the actuator housing.

As a precaution, it should be noted that the numerals used here (“first”, “second”, etc.) serve primarily (only) to distinguish between several similar objects, sizes, or processes, and in particular do not necessarily specify any dependency and/or sequence of these objects, sizes or processes with respect to one another. If a dependency and/or sequence is necessary, this is explicitly stated here or follows in a manner obvious to a person skilled in the art when studying the specifically described embodiment.

A freewheel, also called an overrunning clutch, is a clutch that only works in one direction of rotation. A freewheel can only transmit torque in one direction of rotation. If the direction of rotation is reversed or if the speed of the part to be driven is greater than that of the driving part, the connection is automatically released.

In an example embodiment, the linearly driven actuating element is an actuating tappet and the rotationally driven actuating element is the output shaft. Furthermore, the output shaft can be indirectly mounted on the actuator housing via a third freewheel.

In an example embodiment, the actuator housing comprises a base body, a first cover-like housing body and a second cover-like housing body. The base body of the actuator housing is pot-shaped and comprises a receiving space for the electromotive drive. The first and the second cover-like base body are each attached opposite to each other to the pot-shaped ends of the base body. In an example embodiment, the first cover-like housing base body has a first hydraulic connection and the second cover-like housing base body has a second hydraulic connection.

A fluid-conveying device can be a continuous-flow machine or a positive displacement machine (pump). In order to realize an additional actuating function in addition to the fluid conveying function, the conveying rotor of the fluid-conveying device is connected to the drive shaft being positioned coaxially to the axis of rotation for conjoint rotation therewith. Consequently, the drive shaft is at least indirectly connected to the drive rotor for conjoint rotation therewith. In order to provide the additional actuating function, the eccentric or a cam is connected to the drive shaft via the first freewheel.

In an example embodiment, an axially displaceable and oscillating push rod rests with a first end on the peripheral surface of the eccentric and is positioned with the other end on the freewheel lever. The push rod can be positioned orthogonally to the axis of rotation; alternatively, the push rod can be positioned at an oblique orientation with respect to the axis of rotation. The eccentric transmits a linear oscillating stroke to the freewheel lever, which is positioned indirectly and coaxially on the output shaft, via the push rod which runs radially thereon and is mounted so as to be axially displaceable. The first freewheel drives the output shaft via the push rod and the freewheel lever only in a first direction of rotation of the drive shaft or the electromotive drive. In a second direction of rotation, the first freewheel is overtaken so that only the fluid-conveying device is driven, whereby only the cooling or lubricating function is realized.

The second freewheel is positioned in the rotation center of the freewheel lever between the freewheel lever and the output shaft. Thus, by means of the freewheel lever and the second freewheel, an oscillating rotary movement of the freewheel lever is carried out around the output shaft, wherein this rotary movement is transmitted intermittently to the output shaft exclusively in a first actuating direction due to the second freewheel. In an example embodiment, the output shaft is in turn supported via the third freewheel on the actuator housing, in particular on the second cover-like housing body. This means that the output shaft is secured against rotation in the opposite direction to the actuating direction by the third freewheel during the return stroke of the second freewheel, triggered by a return stroke of the push rod.

In order to utilize the intermittent rotary movement of the output shaft, the output shaft can be guided out of the actuator housing at least at one end. To prevent hydraulic fluid from escaping through the circumferential gap between the actuator housing and the output shaft, a seal is provided between the actuator housing and the output shaft.

In an example embodiment, the angle of rotation of the output shaft is detected directly or indirectly by a sensor, furthermore with the sensor controlling the electromotive drive via electronic components, so that depending on the rotation of the output shaft the electromotive drive can be activated or deactivated. The sensor can directly detect the angle of rotation of the output shaft. Alternatively, the angle of rotation of the output shaft can also be detected indirectly by the sensor determining the adjustment of other components connected to the output shaft, and these values are converted by the electronic components into an angle of rotation of the output shaft.

In an example embodiment, a fourth freewheel is positioned between the conveying rotor and the drive shaft, wherein the fourth freewheel is mounted in the opposite direction of action to the first freewheel. Thus, the fluid-conveying device is not driven during the actuating function of the output shaft.

In an example embodiment, the radial surface of the eccentric and the contact surface of the end of the push rod adjacent to it are designed to be particularly low-friction. A particularly low-friction surface is characterized by a high level of smoothness, i.e., a surface with few protrusions. The term low-friction can be understood to mean that the material pairing of the radial surface of the eccentric and the contact surface of the end of the push rod adjacent to this end has a sliding friction coefficient of less than 0.12. A reduction in friction in the contact area between the push rod and the eccentric leads to a reduction in friction losses and an increase in the life expectancy of both components. In an example embodiment, the eccentric has a higher degree of hardness than the push rod, since material shrinkage can be better compensated by moving the push rod forward without impairing the function of the device or reducing the axial displacement of the push rod. In order to reduce manufacturing and production costs, the first freewheel and/or the second freewheel and/or the third freewheel and/or the fourth freewheel can be identical. Standardization of the freewheels leads to lower procurement costs or manufacturing costs, which means that the actuator can be manufactured more cost-effectively.

In an example embodiment, a return spring counteracting the axial and oscillating movement of the push rod and the freewheel lever in the direction facing away from the axis of rotation is provided. The return spring acts directly on the freewheel lever so that the return stroke of the freewheel lever is carried out safely in the freewheel direction, i.e., against the actuating direction of the second freewheel, and the push rod is kept permanently in contact with the eccentric or cam. For this purpose, the return spring is supported with one end on the actuator housing, more precisely on the second cover-like housing base body, and with the other end on the freewheel lever.

### BRIEF DESCRIPTION OF THE DRAWINGS

Both the disclosure and the technical field are explained in more detail below with reference to the figures. It should be noted that the disclosure is not intended to be limited by the exemplary embodiments shown. In particular, unless explicitly stated otherwise, it is also possible to extract sub-aspects of the subject matter explained in the figures and to combine them with other components and knowledge from the present description and/or figures. In particular, it should be noted that the figures and in particular the proportions shown are only schematic in nature. Identical reference signs indicate the same objects, such that, where applicable, explanations from other figures can also be used. In the drawings:

FIG. 1: shows a longitudinal section of an actuator known from the prior art;

FIG. 2: shows a schematic representation of an example of a modular actuator;

FIG. 3: shows a schematic representation of an example of an actuator for additional actuation of a parking brake; and

FIG. 4: shows a schematic sectional view of the example of a modular actuator for additional actuation of a parking brake according to FIG. 3.

### DETAILED DESCRIPTION

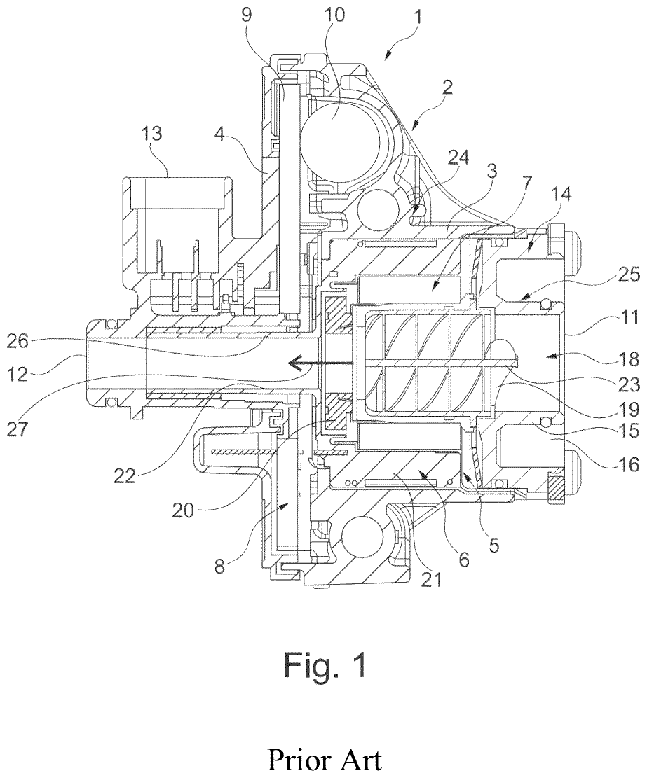

According to FIG. 1, a modular actuator 1 with an actuator housing 2 is known from the prior art. The actuator housing 2 comprises a pot-shaped housing base body 3. The pot-shaped housing base body 3 comprises a receiving space for an electromotive drive 5.

The electromotive drive 5 comprises a stator 6 in which a drive rotor 7 is rotatably positioned. The electromotive drive 5 is controlled via an electronic module 8.

The electronic module 8 comprises a printed circuit board 9 with various electronic components 10. The printed circuit board 9 is positioned within a first cover-like housing body 4, which has an electric connection 13. The first cover-like housing body 4 with the printed circuit board 9 and the electronic components 10 is attached to the pot-like housing base body 3 from the left in FIG. 1.

Furthermore, the modular actuator 1 comprises a hydraulic module 25 with a fluid-conveying device 18. The fluid-conveying device 18 comprises a propeller-like or screw-like conveying rotor 19. In this exemplary embodiment, the fluid-conveying device 18 is designed as a continuous-flow machine. The conveying rotor 19, which can also be referred to as a pump wheel when a pump is used as a fluid-conveying device, is substantially positioned within the drive rotor 7. The conveying rotor 19 is connected to the drive rotor 7 for conjoint rotation. The conveying rotor 19 is driven via the drive rotor 7. An existing bearing of the drive rotor 7 is used for the conveying rotor 19. A separate bearing for the conveying rotor 19 is not required.

The electromotive drive 5 further comprises a ring magnet 20. In FIG. 1, the ring magnet 20 is positioned in an axial direction between the printed circuit board 9 and the conveying rotor 19 of the fluid-conveying device 18. The stator 6 of the electromotive drive 5 comprises a stator overmolding 21. The stator overmolding 21 comprises a tubular attachment 22 which, in FIG. 1, extends from the stator 6 to the left through a corresponding through hole in the guide plate 9. The term “axial” refers to an axis of rotation 23 of the drive rotor 7 of the electromotive drive 5.

The axis of rotation 23 of the drive rotor 7 advantageously coincides with a flow direction 27 of a flow channel 26. In FIG. 1, the flow channel 26 extends from left to right between a first and a second hydraulic connection 11 and 12 in a straight line through the actuator housing 2.

A first hydraulic connection 11 is provided on a second cover-like housing body 14, which is positioned opposite to the first cover-like housing body 4 on the other side of the housing base body 3. The second cover-like housing base body 14 comprises a tubular connecting body 15 which is surrounded by an annular connecting space 16.

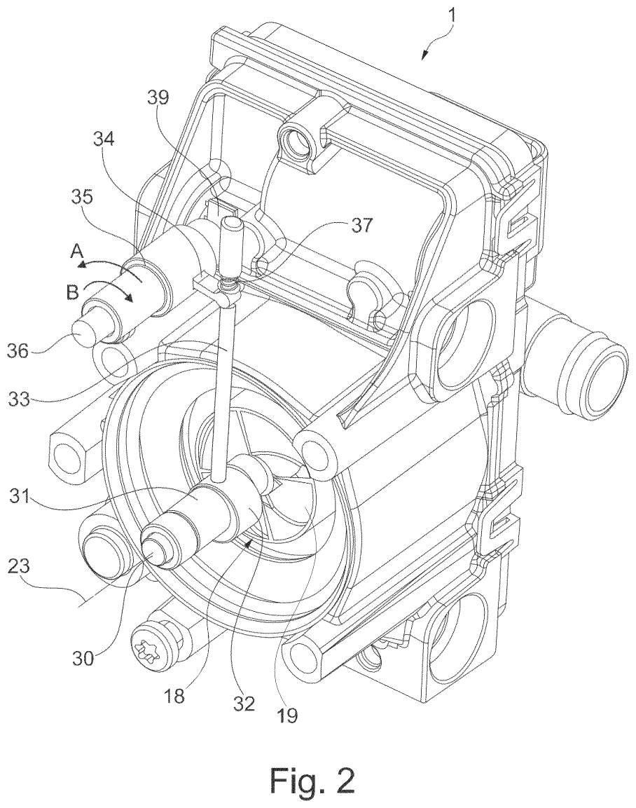

FIG. 2 shows an actuator 1, the basic structure of which is based on the actuator according to FIG. 1 known from the prior art. Reference is made to the description of FIG. 1; in the following, only the differences to the actuator known from the prior art will be described. The actuator 1 according to FIG. 2 differs from the actuator 1 according to FIG. 1 known from the prior art in that, among other things, in addition to the fluid conveying function by means of a continuous-flow machine or displacement machine (pump), an additional actuating function is provided. For this purpose, the conveying rotor 19 of the fluid-conveying device 18 is connected for conjoint rotation to a drive shaft 30 positioned coaxially to the axis of rotation 23. Consequently, the drive shaft 30 is indirectly connected to the drive rotor 7 (see FIG. 1) for conjoint rotation and extends out of the space surrounding the fluid-conveying device 18. In order to provide an additional actuating function, an eccentric 32 or a cam is connected to the drive shaft 30 via a first freewheel 31. The eccentric 32 transmits a linear alternating or oscillating stroke to a freewheel lever 34, which is positioned indirectly and coaxially on an output shaft 36, via a push rod 33 which runs radially thereon and is mounted so as to be axially displaceable. The output shaft 36 represents a rotationally driven actuating element which is guided out of the actuator housing. The output shaft 36 is positioned parallel to the drive shaft 30. However, other alignments are also possible, for example a skewed arrangement of the output shaft 36 relative to the drive shaft 30. The first freewheel 31 drives the output shaft 36 only in a first direction of rotation of the electromotive drive 5. In a second direction of rotation of the drive shaft 30, the first freewheel 31 is overtaken so that only the fluid-conveying device 18 is driven, whereby a cooling and/or lubricating function is realized.

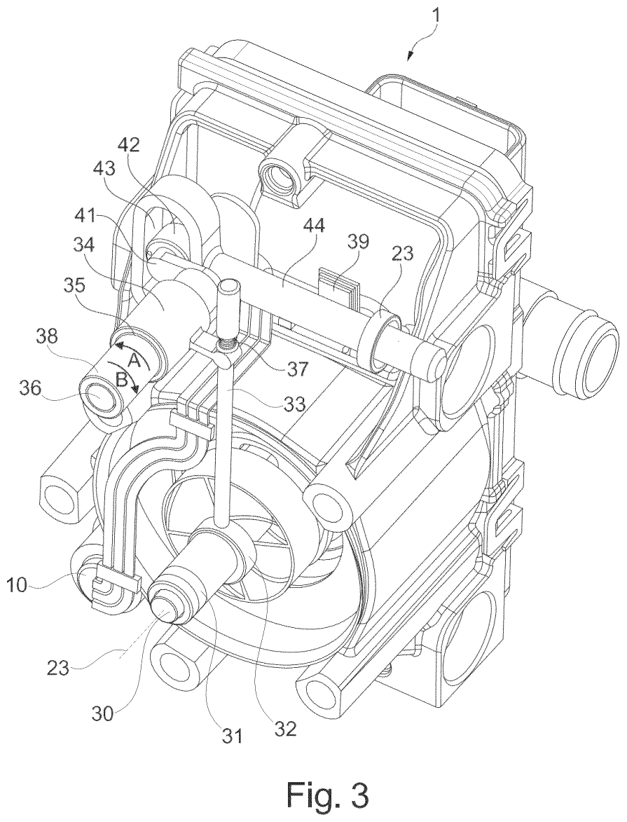

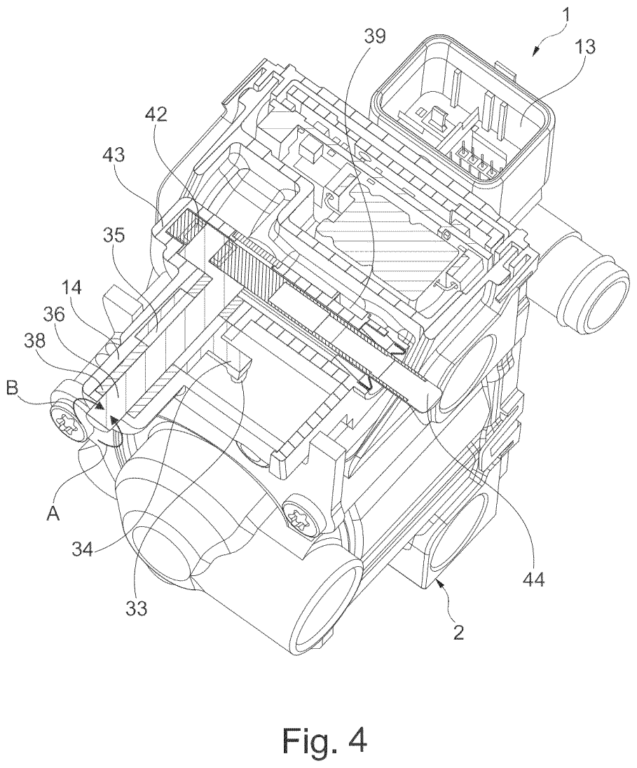

As shown in FIG. 4, a second freewheel 35 is positioned in the rotation center of the freewheel lever 34 between the freewheel lever 34 and the output shaft 36. Thus, by means of the freewheel lever 34 and the second freewheel 35, an oscillating rotary movement of the freewheel lever 34 is carried out, wherein this rotary movement is transmitted intermittently to the output shaft 36 exclusively in a first actuating direction A due to the second freewheel 35. As shown in FIG. 4, the output shaft 36 is in turn supported via a third freewheel 38 on the actuator housing 2, in particular on the second cover-like housing body 14. This means that the output shaft 36 is secured against rotation in the opposite direction to the actuating direction A during the return stroke of the second freewheel 35, triggered by a return stroke of the push rod 33. Furthermore, a return spring 37 (see FIG. 3) acts on the freewheel lever 34 so that the return stroke in the freewheel direction B, i.e., opposite to the actuating direction A of the second freewheel 35, is carried out safely and the push rod 33 is held in contact with the eccentric 32 or the cam. For this purpose, the return spring 37 is supported, although not shown, with one end on the actuator housing 2 or on the second cover-like housing base body 14, and with the other end on the freewheel lever 34.

The output shaft 36 is guided out of the actuator housing 2 through a seal (not shown). Thus, it can perform a rotating actuating function in the external area, wherein a torque is transmitted intermittently via the output shaft 36 at least in the actuating direction A. A sensor 39 is provided on the housing side to detect the angle of rotation or the average rotational speed of the output shaft 36.

In an example embodiment, the fluid-conveying device 18 or the conveying rotor 19 of the fluid-conveying device 18 is driven via a fourth, intermediate freewheel 40 between the conveying rotor 19 and the drive shaft 30, wherein the fourth freewheel 40 is mounted in the opposite direction of action to the first freewheel 31. Thus, the fluid-conveying device 18 is not driven during the actuating function of the output shaft 36.

FIGS. 3 and 4 show a schematic representation of the actuator 1 according to the disclosure for providing a fluid flow and an additional actuation of a further element (not shown), such as a parking brake, by means of a linear actuating element. In order to carry out the actuating function, for example for the parking brake, the electromotive drive 5 is driven in a first direction of rotation, in which the first freewheel 31 transmits torque to the eccentric 32. As a result, the push rod 33 is pushed away from the axis of rotation 23 of the eccentric 32 by the rising eccentric 32 and the second freewheel 35 is rotated in the torque-transmitting actuating direction A, whereby the output shaft 36 is also rotated by a corresponding angle of rotation.

After reaching the highest point of the eccentric 32, the freewheel lever 34 and the push rod 33 follow the trailing edge of the eccentric 32 by means of the return spring 37. As already described above in relation to FIG. 2, this return movement of the push rod 33 and the freewheel lever 34 does not produce any rotation of the output shaft 36 opposite to the actuating direction A, i.e., in the freewheel direction B, since the second freewheel 35 is overtaken in the process.

At the housing-side end of the output shaft 36, an output lever 41 is positioned for conjoint rotation, on which a coaxially rotatably mounted roller 42 is mounted. The axis of rotation of the roller 42 is stacked horizontally to the axis of rotation of the output shaft 36. The roller 42 is in turn mounted in a guide 43, which enables a vertical displacement of the roller 42 in the guide 43. The guide 43 itself is non-positively connected on one side to an actuating tappet 44, which represents the linear actuating element, wherein the actuating tappet 44 is mounted orthogonally to the output shaft 36 in the actuator housing 2 so as to be axially displaceable. If the output shaft 36 is rotated in the actuating direction A so that the output lever 41 rotates counterclockwise and the roller 42 is thus displaced downwards within the guide 43, the end of the actuating tappet 44 facing away from the guide 43 is moved out of the actuator housing 2. In this disengaged position of the actuating tappet 42, the operating load of the parking brake generates a torque on the output shaft 36 in the direction opposite to the actuating direction A, which, however, is held by the third freewheel 38. Furthermore, a return spring (not shown) can also counteract a movement of the actuating tappet 44 out of the actuator housing 2. Upon further rotation of the output shaft 36 in the actuating direction A, a radially rising section of the eccentric 32 follows again, so that the output shaft 36 is intermittently rotated in the actuating direction A. Unlike in FIG. 2, the sensor 39 detects the displacement of the actuating tappet 44 and not the rotation of the output shaft 36. However, even in this example embodiment according to FIGS. 3 and 4, direct sensing of the output shaft 36 is achieved. The sensor 39 detects when the parking brake is almost fully applied, thus reaching the state in which the output lever 41 is rotated maximally in the direction of the actuating tappet 44. This corresponds to a rotation of 180° compared to the representation in FIG. 3. In this state, the electromotive drive 5 is stopped so that the maximally compressed return spring (not shown) between the actuating tappet 44 and the actuator housing 2 exerts a maximum counterforce against the actuating tappet 44, with the output shaft 36 still being held by the third freewheel 38. In this exemplary embodiment, the output shaft 36 only needs to be guided out of the actuator housing if it is to be used for further actuation in addition to the actuating tappet.

In this state, the electromotive drive 5 can remain at a standstill or be driven in a second direction of rotation to operate the cooling and/or lubricating function. Due to the first freewheel 31, the parking brake is not affected. This position represents the open state of the parking brake.

If, however, the parking brake is to be closed, the electromotive drive 5 is again driven in the first direction of rotation so that the parking brake exceeds the dead center described above, with a restoring torque acting on the output shaft 36 in the freewheel direction B via the return spring (not shown). Since this restoring torque acts in the actuating direction A after the dead center has been exceeded and thus in the freewheel direction of the second and third freewheels 35, 38, the output shaft 36 can be freely rotated by the return spring so that the parking brake can quickly close until it reaches its dead center in the closed position, as shown in FIG. 3, and remains stable there. To close the parking lock, it is only necessary to exceed the open dead center of the parking lock.

However, the opposite may also be the case, with the pre-tensioned state representing the closed state and the state according to FIG. 3 representing the open state of the parking brake. In this respect, the device is not fixed.

### LIST OF REFERENCE SYMBOLS

1 Modular actuator
2 Actuator housing
3 Housing base body
4 First cover-like housing body
5 Electromotive drive
6 Stator
7 Drive rotor
8 Electric module
9 Printed circuit board
10 Electronic components
11 First hydraulic connection
12 Second hydraulic connection
13 Electric connection
14 Second cover-like housing body
15 Tubular connecting body
16 Annular connecting space
18 Fluid-conveying device
19 Conveying rotor
20 Ring magnet
21 Stator overmolding
22 Tube-like attachment
23 Axis of rotation
24 Motor module
25 Hydraulic module
26 Flow channel
27 Flow direction
30 Drive shaft
31 First freewheel
32 Eccentric/cam
33 Push rod
34 Freewheel lever
35 Second freewheel
36 Output shaft
37 Return spring
38 Third freewheel
39 Sensor
40 Fourth freewheel
41 Output lever
42 Roller
43 Guide
44 Actuating tappet
A Actuating direction
B Freewheel direction

1. An actuator providing a fluid flow and having a further actuating function, the actuator comprising:
an electromotive drive disposed in an actuator housing, the electromotive drive comprising:
a stator, and
a drive rotor configured to be rotated about an axis of rotation,
a fluid-conveying device, a conveying rotor of the fluid-conveying device connected to the drive rotor for conjoint rotation therewith, and
an eccentric positioned, via a first overrunning clutch, on a drive shaft that is connected coaxially to the conveying rotor, and
a freewheel lever mounted indirectly on an output shaft via a second overrunning clutch, the eccentric causing an oscillating movement of the freewheel lever to in a peripheral direction of the output shaft, and a linear actuating element driven by the oscillating movement and/or a rotationally driven actuating element being guided out of the actuator housing via the oscillating movement, so as to provide the further actuating function.

2. The actuator according to claim 1, wherein the linear actuating element is an actuating tappet and the rotationally driven actuating element is the output shaft.

3. The actuator according to claim 1, wherein the output shaft is mounted indirectly to the actuator housing via a third overrunning clutch.

4. The actuator according to claim 1, further comprising a sensor which detects an angle of rotation of the output shaft.

5. The actuator according to claim 1, further comprising an axially displaceable and oscillating push rod having a first end resting on a peripheral surface of the eccentric and a second end arranged on the freewheel lever.

6. The actuator according to claim 5, further comprising a return spring counteracting: i) an axial and oscillating movement of the push rod, and ii) the freewheel lever in a direction facing away from the axis of rotation.

7. The actuator according to claim 3, further comprising a fourth overrunning clutch arranged between the conveying rotor and the drive shaft.

8. The actuator according to claim 7, wherein at least two of the first overrunning clutch or the second overrunning clutch or the third overrunning clutch or the fourth overrunning clutch are structurally identical.

9. The actuator according to claim 2, wherein the actuator housing comprises a base body, a first cover-like housing body, and a second cover-like housing body.

10. The actuator according to claim 9, wherein the first cover-like housing body has a first hydraulic connection and the second cover-like housing body has a second hydraulic connection

11. An actuator providing fluid flow and having a further actuating function, the actuator comprising:
an actuator housing;
an electromotive drive disposed in the actuator housing, the electromotive drive comprising a stator and a drive rotor rotatable about an axis,
a fluid-conveying device:
disposed within the housing, and
connected to the drive rotor for conjoint rotation therewith, and
an eccentric arranged via a first overrunning clutch on a drive shaft that is connected coaxially to the fluid-conveying device, the eccentric rotating via rotational movement of the fluid-conveying device, wherein rotation of the eccentric provides the further actuating function.

12. The actuator of claim 11, further comprising an electronic module that controls the electromotive drive, the electronic module disposed within the actuator housing.

13. The actuator of claim 12, wherein the electronic module further comprises a printed circuit board disposed within the actuator housing.

14. The actuator of claim 12, wherein the electromotive drive is disposed axially between the electronic module and the eccentric relative to the axis.

15. The actuator of claim 12, further comprising a push rod, and the push rod is linearly actuated via rotation of the eccentric so as to provide the further actuating function.

16. The actuator of claim 15, wherein the push rod is located outside of the actuator housing.

17. The actuator of claim 12, further comprising a freewheel lever mounted to an output shaft via a second overrunning clutch, and the freewheel lever is rotated via rotation of the eccentric so as to provide the further actuation function.

18. The actuator of claim 17, wherein the freewheel lever and the output shaft are located outside of the actuator housing.

19. The actuator of claim 17, wherein the output shaft is parallel to the drive shaft.

20. The actuator of claim 17, further comprising a sensor which detects an angle of rotation of the output shaft.
